(19) United States
(12) Patent Application Publication
(10) Pub. No.: US 2023/0084802 A1
(43) Pub. Date: Mar. 16, 2023

(54) INFORMATION PROCESSING METHOD, INFORMATION PROCESSING DEVICE, AND INSTRUCTIONS FOR INFORMATION PROCESSING

(71) Applicant: SEGA CORPORATION, Tokyo (JP)

(72) Inventor: Takahiro Otomo, Tokyo (JP)

(73) Assignee: SEGA CORPORATION, Tokyo (JP)

(21) Appl. No.: 17/989,821

(22) Filed: Nov. 18, 2022

Related U.S. Application Data
(63) Continuation of application No. PCT/JP2021/018882, filed on May 18, 2021.

(30) Foreign Application Priority Data
May 19, 2020 (JP) 2020-087188

(51) Int. Cl. G07F 17/32

(52) U.S. Cl. CPC G07F 17/323; G07F 17/3237; G07F 17/3269; G07F 17/3211

(57) ABSTRACT

An information processing method includes: storing in a storage, information indicating that a user is a paid member for a fixed period; providing an advantage in a game to the user for the fixed period; managing usage frequency of the advantage by the user for the fixed period; and sending the user notification information including the usage frequency as the fixed period elapses.

### BACKGROUND

### Technical Field

The present invention relates to an information processing method, an information processing device, and instructions for information processing.

### Description of the Related Art

Games in which an advantage is provided to a user who has become a paid member who pays a fee at regular intervals (such as a monthly fee) have been known in the past.

In relation to this, Patent Literature 1 discloses a technique in which login bonuses for a fixed period, etc., are collectively granted to users (players) who have paid a set fee for a fixed period of time.

### PATENT LITERATURE

Patent Literature 1: Japanese Patent No. 6,168,230

In a game such as this, when a user registers (subscribes) as a paid member, the membership is often automatically renewed every time a fixed period elapses. That is, a user who is a paid member continues to pay a set fee at regular intervals unless the user cancels the paid membership (performs an operation to stop automatic renewal). Accordingly, even if the user who is a paid member does not make full use of the advantages that are provided, that user will continue to pay the fee at regular intervals, which may be disadvantageous.

### SUMMARY

One or more embodiments provide a technological improvement over such conventional information processing devices. In particular, an information processing device, an information processing method, and instructions for information processing according to one or more embodiments can prevent a user who is a paid member from suffering any disadvantages. This provides a practical, technological improvement over conventional information processing devices that would be readily appreciated by those skilled in the art. Further details regarding the various improvements and advantages will become apparent from the descriptions that follow.

An information processing device according to one or more embodiments includes a storage means (a storage) for storing whether or not a user is a paid member for a fixed period; a provision means (a controller) for providing an advantage in a game to a user who is a paid member for the fixed period; a management means (the controller) for managing the usage frequency of the advantage by a user who is a paid member for the fixed period; and a notification means (the controller) for sending a user who is a paid member notification information including the usage frequency of the advantage as the fixed period elapses.

Also, in one or more embodiments, the notification means sends the notification information to a user whose usage frequency of the advantage during a portion of or over the entire fixed period is less than a specific value.

Also, one or more embodiments, the notification information includes statistical information related to the usage frequency of the advantage during a portion of or over the entire fixed period.

Also, in one or more embodiments, the notification information includes information for displaying a screen for instructing the cancellation of paid membership.

Also, in one or more embodiments, the notification information includes information indicating that the advantage to be provided in the next fixed period will be automatically changed.

Also, in one or more embodiments, the notification information includes information for displaying a screen on which the user can arbitrarily change the advantage to be provided in the next fixed period.

Also, in one or more embodiments, the notification information includes information for displaying a screen on which the user can use the advantage.

Also, in one or more embodiments, the notification information includes information indicating that the advantage has been automatically used.

Also, in one or more embodiments, a computer is caused to function as an update means for performing automatic updates that allow a user whose usage frequency of the advantage during a portion of or over the entire fixed period is equal to or greater than a specific value to renew as a paid member for the next fixed period as well.

Also, an information processing method of one or more embodiments includes: storing whether or not a user is a paid member for a fixed period; providing an advantage in a game to a user who is a paid member for the fixed period; managing the usage frequency of the advantage by a user who is a paid member for the fixed period; and sending a user who is a paid member notification information including the usage frequency of the advantage as the fixed period elapses.

According to one or more embodiments, a user who is a paid member can be prevented from suffering a disadvantage.

### BRIEF DESCRIPTION OF THE DRAWINGS

FIG. 1 is a block diagram showing an example of the overall configuration of a game system according to one or more embodiments;

FIG. 2 is a diagram schematically showing an example of the hardware configuration of a server device according to one or more embodiments;

FIG. 3 is a diagram showing an example of the hardware configuration of a smart phone according to one or more embodiments, as the terminal device shown in FIG. 1;

FIG. 4 is a block diagram showing an example of the functional configuration of a server device according to one or more embodiments;

FIG. 5 is a flowchart showing an example of the flow of processing performed by the functional means shown in FIG. 4 in the game system according to one or more embodiments;

FIG. 6 is a diagram showing an example of the notification screen according to one or more embodiments.

### DETAILED DESCRIPTION

One or more embodiments of the present invention will now be described with reference to the appended drawings. To facilitate understanding of the description, components and steps that are the same will be numbered the same as much as possible in the drawings, and redundant description will be omitted.

Overall Configuration

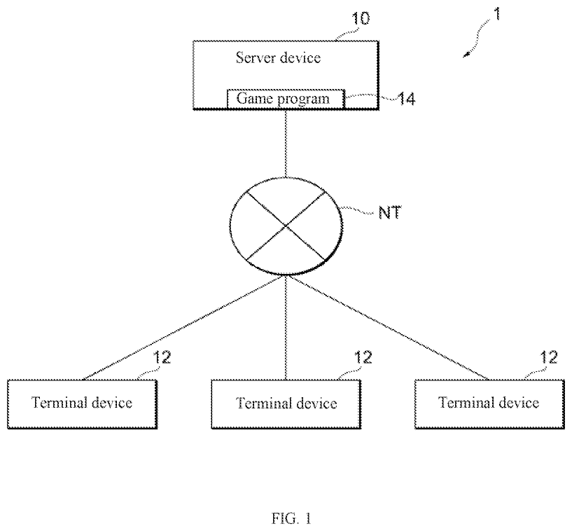

FIG. 1 is a block diagram showing an example of the overall configuration of a game system 1 according to one or more embodiments.

As shown in FIG. 1, a game system 1 comprises a server device 10 and one or more terminal devices 12. The server device 10 and terminal devices 12 are connected so as to be able to communicate via a communication network NT such as an intranet, the Internet, or a telephone line.

The server device 10 is an information processing device that provides the execution results of the game obtained by executing the game program (game instructions stored in a non-transitory computer-readable recording medium) 14, or the game program 14 itself, to the user of each terminal device 12 via the communication network NT. In one or more embodiments, the server device 10 provides the game program 14 itself to the users of the terminal devices 12.

Each terminal device 12 is an information processing device belonging to a user, and is an information processing device that provides a game to a user by executing the game program 14 received from the server device 10 after the program has been installed. Examples of these terminal devices 12 include video game machines, arcade game machines, mobile phones, smartphones, tablets, personal computers, and various other such devices.

Hardware Configuration

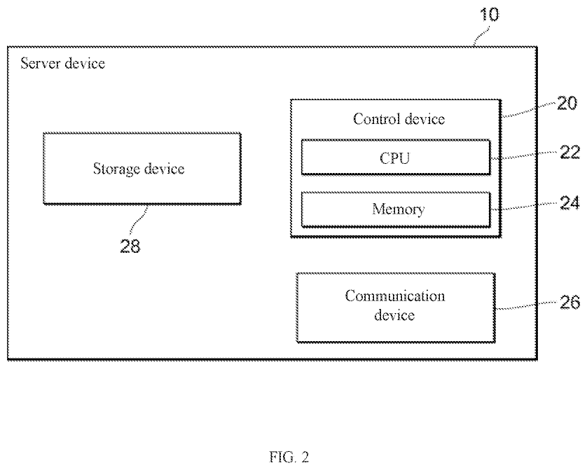

FIG. 2 is a diagram schematically showing an example of the hardware configuration of the server device 10.

As shown in FIG. 2, the server device 10 comprises a control device 20, a communication device 26, and a storage device 28. The control device 20 mainly comprises a CPU (central processing unit) 22 and a memory 24.

In the control device 20, the CPU 22 functions as various functional means by executing specific programs stored in the memory 24, the storage device 28, or the like. These functional means will be described in detail below.

The communication device 26 is constituted by a communication interface or the like for communicating with an external device. The communication device 26 sends and receives various kinds of information to and from the terminal device 12, for example.

The storage device 28 is constituted by a hard disk or the like. The storage device 28 stores various kinds of program and various kinds of information necessary for executing processing in the control device 20, including the game program 14, as well as information about processing results.

The server device 10 can be realized by using an information processing device such as a dedicated or general-purpose server computer. Also, the server device 10 may be constituted by a single information processing device, or may be constituted by a plurality of information processing devices distributed on the communication network NT. Also, FIG. 2 shows only a part of the main hardware configuration of the server device 10, and the server device 10 can comprise other components that are ordinarily provided to a server. Also, the hardware configuration of the plurality of terminal devices 12 may have the same configuration as the server device 10, except for comprising an operating means, a display device, and a sound output device, for example.

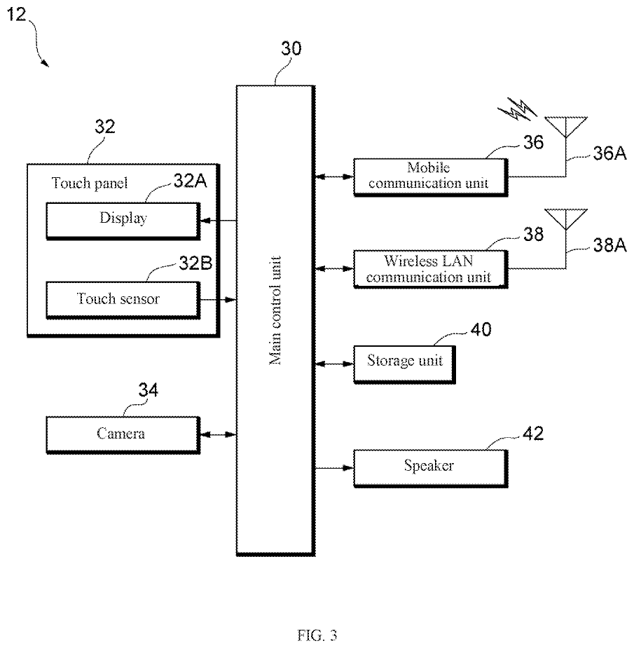

FIG. 3 is a diagram showing an example of the hardware configuration of a smartphone serving as the terminal device 12 shown in FIG. 1.

As shown in FIG. 3, the terminal device 12 comprises a main control unit 30, a touch panel (touch screen) 32, a camera 34, a mobile communication unit 36, a wireless LAN communication unit 38, a storage unit 40, and a speaker 42.

The main control unit 30 includes a CPU, a memory, and the like. This main control unit 30 is connected to the touch panel 32 (used as a display input device), the camera 34, the mobile communication unit 36, the wireless LAN communication unit 38, the storage unit 40, and the speaker 42. The main control unit 30 has the function of controlling these connected devices.

The touch panel 32 has both a display function and an input function, and is constituted by a display 32A that handles the display function, and a touch sensor 32B that handles the input function. In one or more embodiments, the display 32A can display game images including button images, a cross key image, a joystick image, and other such operation input images. The touch sensor 32B can sense the input position of the user with respect to a game image.

The camera 34 has the function of capturing still and/or moving images and storing these images in the storage unit 40.

The mobile communication unit 36 is connected to a mobile communication network via an antenna 36A, and has the function of communicating with other communication devices that are connected to this mobile communication network.

The wireless LAN communication unit 38 is connected to the communication network NT via an antenna 38A, and has the function of communicating with other devices, such as the server device 10, that are connected to the communication network NT.

The storage unit 40 stores various kinds of programs and data, such as the game program 14, and play data indicating user information or the progress of the game in the game program 14. This play data may be stored in the server device 10.

The speaker 42 has the function of outputting game sounds and so forth.

Game Overview

The game according to one or more embodiments includes a quest or a lottery game in which a user acquires characters, as an example of content. Lottery games are sometimes referred to as gacha (loot box), raffle, summoning, or the like. Quests are sometimes referred to as battle games, dungeons, searches, missions, or the like.

In one or more embodiments, there are one or more types of lottery game, each of which has a different name (title). A lottery game can be selected by the user on the menu screen, etc., of the lottery game. In one or more embodiments, when the user selects a lottery game from among one or more types of lottery game, a screen is displayed that allows for a one-time lottery, in which that lottery game is executed once, or continuous lottery, in which that lottery game is executed 10 times in a row. This one-time lottery is sometimes referred to as a single gacha, a one-time raffle, a one-time summoning, or the like. Also, this continuous lottery is sometimes referred to as a ten-in-a-row gacha, a ten-draw raffle, a ten-time summoning, or the like. Then, the user is provided with a randomly selected character from the lottery target character group (lottery target content group) corresponding to that lottery game, on the basis of an instruction (request) from the user to execute a one-time lottery or a continuous lottery. This lottery game is executed on the basis of the consumption of credit. A continuous lottery consumes more credit than in a one-time lottery. Examples of this credit include paid-for items (paid items) and free items (unpaid items). A paid-for item is an item that can be acquired by a user through a purchase transaction (payment in cash or electronic money, credit card payment, etc.). Examples of paid-for items include paid-for stones, paid-for gacha tickets, paid-for coins, and the like. A free item is an item that can be acquired by the user through game play (execution of various games). For example, free items can be acquired as rewards for logging in, clearing quests, completing missions, interacting with friends, and so on. Examples of free items include free stones, free gacha tickets, stamina recovery items, game coins, friend points, and the like. Also, these paid-for items and free items can be used not only for executing lottery games, but also for various other purposes, such as restoring stamina and continuing quests. Paid-for items have more value than free items. For example, in a lottery game that can be executed by consuming only paid-for items, it is easier to acquire a character with a higher rarity (rarity value) than in a lottery game that can be executed by consuming free items. Paid-for stones and free stones are sometimes referred to as “stones.”

Also, in one or more embodiments, there are one or more types of quest, each with a different name (title). A quest can be selected by the user on a quest menu screen or the like. In one or more embodiments, a quest is executed on the basis of an instruction (request) made by the user to select that quest from among one or more types of quest. This quest is executed on the basis of consuming a consumable stamina value associated with the quest from the user's current stamina value. The user cannot execute (play) the quest if the consumable stamina value associated with that quest is greater than the user's current stamina value. This stamina is also referred to as life, action points (AP), battle points (BP), and so on. The user's current stamina value may be consumed at the end of the quest (when the quest is cleared or the user retires).

Also, in one or more embodiments, a quest is executed in which a team made up of (constituted by) one or more characters possessed by the user (possessed characters) battles against enemy characters. In this quest, for example, the user instructs the characters constituting the team (the characters in the team) to attack and so forth. Also, in this quest, the user aims to reduce the hit points of an enemy character to zero or less by using the ability parameters and skills possessed by the characters on the team. When a quest has been cleared, the user obtains clearance rewards, such as free items, game coins, characters, and user experience values. With a quest that the user has already cleared, free stones may not be obtained. Also, if a quest cannot be cleared, the user selects whether to continue the quest by consuming paid stones, free stones, continuance items, or the like, or to retire from the quest. Continuation here is when a user who has not cleared a quest is given a continuation right to keep playing the quest.

Also, with the game according to one or more embodiments, an advantage is provided to the user when the user becomes a paid member who pays a set fee at regular intervals (such as a monthly fee). This advantage is not provided to users who are not paid members (general member users). Examples of this advantage include the right to use (execute) various events at a low price (such as items or current stamina values) or for free, removing restrictions (raising), by a specific amount, on the predetermined usage upper limit (usage limit) for users who are not paid members, increasing quest clearance rewards, and giving discounts and benefits (extras) when purchasing or exchanging various items. Examples of events include special lottery games, special quests, recovery of current stamina values, and the like. This event can be used only a specific number of times (such as once) within a specific time interval (such as 24 hours, one week, or one month). Examples of usage upper limits include the number of characters that can be possessed (possession limit), the number of friends that can be registered (registration limit), the number of team formations including possessed characters that can be stored (formation limit), the number of points that can be acquired in a specific time interval (point limit), the number of times you can purchase or exchange items with benefits (repetition limit), the number of items or possessed characters that can be transferred or lent to other users (transfer limit or loan limit), and the number of commands and strategies (such as priority actions of characters in the team) that can be selected by the user when executing a quest (selection limit).

Functional Means

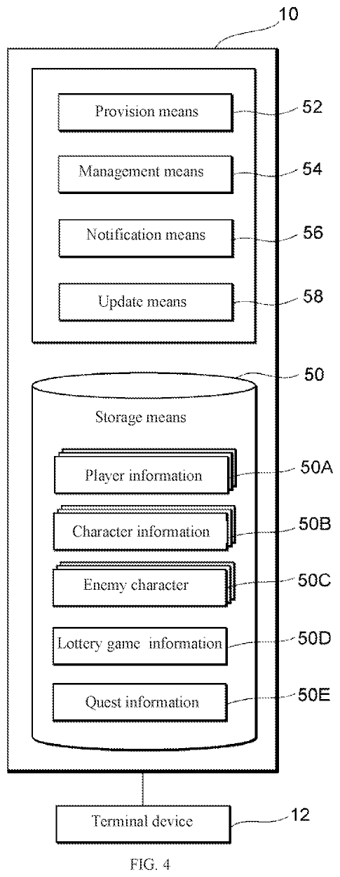

FIG. 4 is a block diagram showing an example of the functional configuration of the server device 10.

As shown in FIG. 4, the server device 10 comprises a storage means 50, a provision means 52, a management means 54, a notification means 56, and an update means 58 as functional components. The storage means 50 here is realized by one or more storage devices 28. Functional means other than the storage means 50 are realized by causing a control device 20 to execute a game program 14 stored in the storage device 28 or the like.

The storage means 50 is a functional means for storing user information 50A, character information 50B, enemy character information 50C, lottery game information 50D, quest information 50E, and the like.

The user information 50A is stored for each user in association with the user ID for that user. This user information 50A includes, for example, the user's name and age, possessed character information, possessed item information, stamina information, qualification information, and advantage information. Possessed character information includes the character ID and ability parameters of each character possessed by the user (possessed characters). Ability parameters are, for example, a character's level, hit points, attack power, defense power, and the like. The level rises when a character acquires character experience values through fusion or the like. As the character's level increases, the hit points, attack power, defense power, and so forth also increase. Possessed item information includes the number of items possessed by the user. Examples of such items include paid stones, paid gacha tickets, free stones, and free gacha tickets. Stamina information includes the current stamina value and the stamina upper limit value. The current stamina value is the value consumed when the user executes various types of quest. This current stamina value increases by a specific amount (such as 1) over time (such as 3 minutes), and is restored to the stamina upper limit value. Also, this current stamina value is restored beyond the stamina upper limit value when the user consumes paid stones, free stones, stamina recovery items, and the like. This stamina upper limit increases as the user's user rank rises. The user rank rises, for example, when the user acquires user experience values by playing games (such as quests and missions). Qualification information includes the user's membership type and renewal information. Membership type includes a value (such as a flag) indicating whether or not a user is a paid member for a fixed period. This membership type includes, for example, paid members and general members. Renewal information includes a value (such as a flag) indicating whether or not the user will continue to be a paid member for the next fixed period. Advantage information is information that is stored when the membership type of the user is a paid member, and is stored for each advantage in association with the advantage ID. This advantage information includes, for example, the usage frequency and the number of available uses. The usage frequency includes the number of times the user has used an advantage during the fixed period. For instance, if the advantage is the provision of the right to use (execute) an event, the usage frequency includes the number of times the user has used (executed) that event. Also, for example, if the advantage is to raise the usage upper limit (usage limit) by a specific amount, the usage frequency includes the quantity that the user has used the raised specific amount (increased amount). Also, for example, if the advantage is an increase in quest clearance rewards, the usage frequency includes the amount of the increased clearance reward. Also, for example, if the advantage is that a benefit (extra) is given, the usage frequency includes the quantity in which the benefit is given. The number of available uses includes the number (remaining number) of times that the user can use an advantage. That is, if the number of available uses of a certain advantage is zero, the user cannot use that particular advantage. This number of available uses is updated to an initial value (specific number of times) at specific time intervals, for example.

The character information 50B is stored for each character in association with the character ID of that character. The character information 50B includes, for example, the name and an image (design) of the character, rarity, initial values of ability parameters (such as hit points, attack power, defense power, etc., at level 1), maximum values (such as hit points, attack power, defense power, etc., at level 100), skills, and the like. Rarity includes numerical values from 1 to 6, for example. This numerical value is sometimes indicated by the number of stars, for example. Here, characters with high rarity are set to have ability parameters and skills that are advantageous for the game (such as in quests and missions).

The enemy character information 50C is stored for each enemy character in association with the character ID of that enemy character. This enemy character information 50C includes, for example, the name and an image of the enemy character, ability information, reward information, and the like. Ability information includes ability parameters and skills. Reward information is information related to quest clearance rewards. This reward information includes user experience values, game coins, and drop information. Drop information includes the character ID of characters that the user is allowed to obtain as a reward for clearing a quest, and the drop rate. The drop rate is the probability that the user will obtain that character.

The lottery game information 50D is stored for each lottery game in association with the lottery game ID of that lottery game. The lottery game information 50D includes, for example, the name (title), lottery target information, and lottery price. The lottery target information includes the character ID of the characters that make up a lottery target character group, which is the lottery target of the lottery game, and the appearance frequency (weight) associated with that character ID. The appearance frequency includes a numerical value from 0 to 10, for example. The appearance frequency is set to a lower numerical value for characters with a high rarity, and to a higher numerical value for characters with a low rarity. Within a given rarity, characters (pickup characters) that appear more frequently than other characters may be provided. Here, the lottery probability of one lottery target character is a value obtained by dividing the appearance frequency set for that lottery target character by the total value of the appearance frequencies set for the various lottery target characters. More specifically, if the appearance frequency set for one lottery target character is 2, and the total value of the appearance frequencies set for the various lottery target characters is 400, the lottery probability of that one lottery target character is 2/400 (0.5%). Also, with a normal lottery game that can be played by general members and paid members, for example, the appearance frequency of the various lottery target characters is set so that the lottery probability will be higher for a lottery target character with a lower rarity. Also, with a special lottery game that can be played only by paid members, for example, the appearance frequency of the various lottery target characters is set so that the lottery probability will be higher for a lottery target character with a higher rarity. The lottery price includes the number of consumable items required to execute the lottery. This lottery price is lower for a special lottery game that can be executed only by paid members than for a normal lottery game that can be executed by general members and paid members. For instance, the lottery price for a special lottery game does not require the consumption of items.

The quest information 50E is stored for each quest in association with the quest ID of that quest. This quest information 50E includes, for example, the name (title), character appearance information, the quest price, and quest rewards. The character appearance information includes character IDs of enemy characters that appear in the various stages within the quest. The quest price includes the consumable stamina values required to execute the quest. For instance, the quest price is lower for special quests that can only be executed by paid members than for normal quests that can be executed by general members and paid members. More specifically, the quest price for a normal quest is 10 in terms of the consumable stamina value. On the other hand, the quest price for a special quest is 5 in terms of the consumable stamina value. The quest rewards include quest clearance rewards. These quest rewards include free items (free stones), characters, the right to use a lottery game (such as a free gacha ticket), and the like. For example, if the quest is a normal quest that can be executed by general members and paid members, the quest reward includes one free stone. Also, if the quest is a special quest that can only be executed by paid members, for example, the quest reward includes one free stone and one free gacha ticket.

The provision means 52 is a functional means for providing one or more advantages to a user who is a paid member. In one or more embodiments, the provision means 52 provides advantages in the game to a user who is a paid member for a fixed period. For example, the provision means 52 sets the number of available uses for each advantage in the advantage information of the user information 50A. Also, the provision means 52 updates the number of available uses to an initial value (specific number) at specific time intervals. Consequently, the provision means 52 can provide a user who has paid the monthly fee for May with the right to use (execute) a special lottery game just once in the month of May, or can raise the upper limit of the number of points that can be acquired in a single day in the month of May from 100 points to 200 points. On the other hand, the provision means 52 does not provide advantages to users who are general members.

Also, the provision means 52 automatically uses an advantage for users whose usage frequency of that advantage during a fixed period is less than a specific value. This specific value may be a specific number of times (such as once), or a value based on statistical information about the usage frequency associated with the advantage of each user who is a paid member (such as the mean value, median value, mode value, etc.). This specific value may vary depending on the user who is a paid member. For instance, a higher value may be set for a user who has been a paid member for a long time, and a lower value may be set for a user whose has been paid member for less time. For example, the provision means 52 automatically uses (executes) a special lottery game and provides the user with characters chosen in the special lottery game. In this special lottery game that is automatically used, the lottery probability of some of the lottery target characters (such as characters with the highest rarity) may be lowered, or the lottery price may be raised, more than in the special lottery game that is used according to an instruction from the user. Also, for example, the provision means 52 automatically uses (executes) a special quest and provides the user with a clearance reward for that special quest. Furthermore, in this special quest that is automatically used, the amount of the clearance reward may be lowered more than in a special quest that is used according to an instruction from the user.

The management means 54 is a functional means for managing information related to advantages for users. In one or more embodiments, the management means 54 manages the usage frequency and the number of available uses of an advantage to be provided to a user who is a paid member, in the advantage information of the user information 50A. For example, the management means 54 changes the managed usage frequency each time the advantage to be provided to the user is changed. Also, for example, every time the user uses an advantage, the management means 54 increases the usage frequency corresponding to that advantage and decreases the number of available uses corresponding to that advantage. More specifically, if the user has used a special lottery game once (executed once), the management means 54 increases the usage frequency associated with that special lottery game by one time, and decreases the number of available uses by one.

Also, the management means 54 calculates statistical information about the usage frequency associated with advantages for users who are paid members. For instance, the management means 54 calculates statistical information about the usage frequency (the number of times used) (such as the mean value, median value, mode value, etc.) for the special lottery game during a portion of or over the entire fixed period.

The notification means 56 is a functional means for sending notification information to the user. In one or more embodiments, the notification means 56 sends a user, who is a paid member, notification information including the usage frequency of advantages as the fixed period elapses. The timing of this notification may be before the user pays the fee set for the next fixed period (before renewing the paid membership), or may be the period in which the user can still cancel the payment of the set fee for the next fixed period. For instance, before the certain date (such as May 26) on which the fixed period (such as the month of May) ends, the notification means 56 sends notification information including the usage frequency of advantages by the user during a portion of the fixed period (such as from May 1 to May 25). Also, for example, after the fixed period (such as the month of May) ends (such as on June 1), the notification means 56 sends notification information including the usage frequency of advantages by the user during the entire fixed period.

Also, the notification means 56 sends notification information to users whose usage frequency of advantages during a portion of or over the entire fixed period is less than a specific value. For instance, before a certain date (such as May 26) on which a fixed period (such as the month of May) ends, the notification means 56 sends notification information including the usage frequency of a special quest to users whose usage frequency is less than 10 times during a portion of the fixed period (such as from May 1 to May 25). Also, for example, after the fixed period (such as the month of May) ends (such as on June 1), the notification means 56 sends notification information including this usage frequency to users whose usage frequency of a special quest is less than 10 times during the entire fixed period. Specific examples of the various kinds of information included in the notification information will be described below. These specific examples may be combined with each other.

(1) Statistical Information

For example, the notification information includes statistical information related to the usage frequency of an advantage during a portion of or over the entire fixed period. Examples of this statistical information include values (such as rounded values) based on the mean value, median value, mode, etc., of the usage frequency associated with each user who is a paid member.

(2) Cancel Button

For example, the notification information includes information to display a screen for instructing the cancellation of paid membership. Examples of this information include a code (such as a URL) for switching to a screen (cancellation screen) on which the user can cancel his paid membership after the next fixed period (such as the month of June), and a cancel button (instruction area) that includes a code for a pop-up display of that screen. When this cancel button is pressed by the user, a screen on which the user can cancel his paid membership is displayed.

(3) Renewal Button

For example, the notification information includes information to display a screen for instructing the renewal of paid membership. Examples of this information include a code (such as a URL) for switching to a screen (renewal screen) on which the user can renew his paid membership after the next fixed period (such as the month of June), and a renewal button (instruction area) that includes a code for a pop-up display of that screen. When the renewal button is pressed by the user, a screen on which the user can renew his paid membership is displayed.

(4) Advantage Change Information

For example, the notification information includes information to indicate that the advantage to be provided in the next fixed period will be automatically changed, regardless of any instruction from the user. More specifically, the notification information includes advantage change information indicating that if an advantage provided during a fixed period (such as the month of May) is the right to use a special lottery game and a special quest, the right to use special quests and the recovery of current stamina values will be provided during the next fixed period (such as the month of June).

(5) Advantage Change Button

For example, the notification information includes information to display a screen (change screen) on which the user can arbitrarily change (select) the advantage to be provided in the next fixed period. More specifically, the notification information includes information to display a screen for selecting one or more advantages to be provided during the next fixed period (such as the month of June) (for example, the right to use a special lottery game, or the right to use the recovery of the current stamina values, an increase in various kinds of usage limits, etc.). Examples of this information include a code (such as a URL) for switching to a screen (selection screen) on which the user can select an advantage, and an advantage selection button (instruction area) that includes a code for a pop-up display of that screen. When the advantage selection button is pressed by the user, a screen on which the user can select an advantage is displayed.

(6) Advantage Use Button

For example, the notification information includes information to display a screen on which the user can use an advantage. More specifically, the notification information includes information to display a screen for using an advantage (such as a special lottery game) whose usage frequency is less than a specific value during the fixed period. Examples of this information include a code (such as a URL) for switching to a screen on which the user can use an advantage (such as a screen for executing a special lottery game), and an advantage use button (instruction area) that includes a code for a pop-up display of that screen. When this advantage use button is pressed by the user, a screen on which the user can use the advantage is displayed.

(7) Automatic Use Information

For example, the notification information includes information to indicate that the advantage has been automatically used. More specifically, the notification information includes automatic use information indicating that an advantage (such as a special lottery game or a special quest) has been automatically used (executed). This automatic use information includes information indicating the characters obtained by the user through automatic use of advantage, clearance rewards, and so forth.

The update means 58 is a functional means for updating whether or not to renew the paid membership. In one or more embodiments, the update means 58 performs automatic updates that allow users whose usage frequency of an advantage during a portion of or over the entire fixed period is equal to or greater than a specific value to renew as paid members for the next fixed period, regardless of any instruction from the user. For example, the update means 58 performs an automatic update to renew the paid membership for the next fixed period (such as the month of June) for users whose usage frequency of a special lottery game for a fixed period (such as the month of May) is at least once and whose usage frequency of a special quest is at least 10 times. More specifically, the update means 58 sets a value (such as a flag) at which the user will renew as a paid member for the next fixed period in the renewal information of the qualification information in the user information 50A.

Also, when the user gives an instruction to cancel his paid membership, or when the usage frequency of the advantage by the user during a portion of or over the entire fixed period is less than a specific value, the update means 58 does not renew the paid membership after the next fixed period, and the user becomes a general member. More specifically, the update means 58 sets a value at which the user will not renew as a paid member for the next fixed period in the renewal information of the qualification information in the user information 50A.

Processing Flow

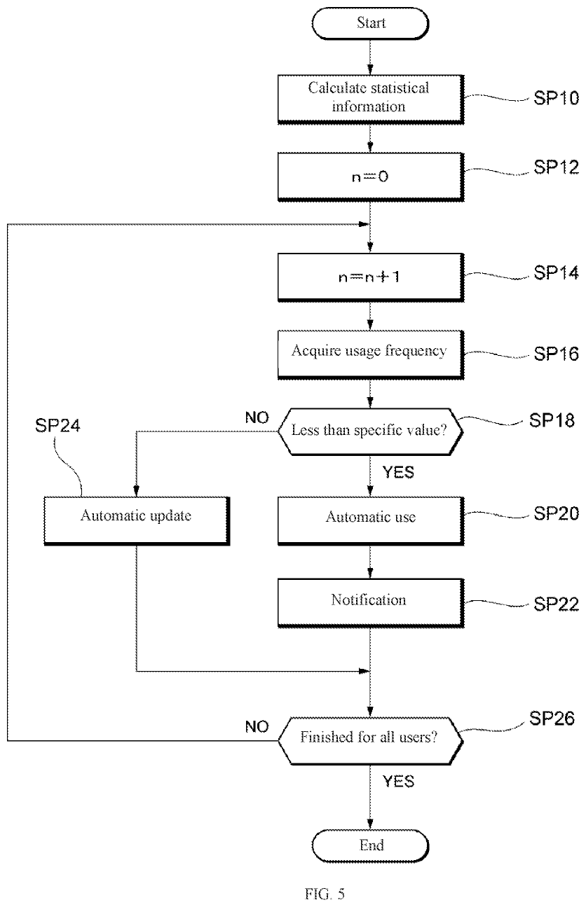

FIG. 5 is a flowchart showing an example of the flow of processing performed by the functional means shown in FIG. 4 in the game system according to one or more embodiments. Also, the processing in the following steps is started, for example, after a fixed period (such as the month of May) ends (such as at 12:00 a.m. on June 1). The order and details of the following steps can be modified as needed.

Step SP10

The management means 54 refers to the advantage information of each user information 50A and calculates statistical information about the usage frequency associated with the advantage of each user who is a paid member. For example, the management means 54 refers to the usage frequency (number of times used) of special lottery games and special quests by each user who is a paid member for the entire fixed period and calculates statistical information about each of the usage frequencies. The processing then moves to the processing of step SP12.

Step SP12

The management means 54 plugs in 0 for the integer n for specifying each user who is a paid member. The processing then moves to the processing of step SP14.

Step SP14

The managing means 54 increments the integer n. The processing then moves to the processing of step SP16.

Step SP16

The management means 54 acquires the usage frequency associated with the advantage of the user who is the n-th paid member. More specifically, the management means 54 acquires the usage frequency (the number of times used) of special lottery games and special quests during the entire fixed period by the user. The processing then moves to the processing of step SP18.

Step SP18

The management means 54 determines whether or not the usage frequency acquired in step SP16 is less than a specific value. For example, the management means 54 determines whether or not this usage frequency is less than the statistical information (such as the average value) calculated in step SP10. More specifically, if the usage frequency of a special lottery game by the user who is the n-th paid member is less than 1 time, or if the usage frequency of a special quest by that user is less than 10 times, the management means 54 makes a positive determination. Then, when the determination is positive, the processing proceeds to step SP20. On the other hand, if the determination is negative, the processing proceeds to step SP24.

Step SP20

The provision means 52 automatically uses an advantage for which the usage frequency by the user who is the n-th paid member is less than a specific value. For example, if the usage frequency of a special lottery game by this user is less than 1 time, the provision means 52 uses (executes) that special lottery game regardless of any instruction from the user and provides the selected lottery character to the user. The processing then moves to the processing of step SP22.

Step SP22

The notification means 56 sends notification information, including the usage frequency and the like acquired in step SP16, to the user who is the n-th paid member. For example, the notification means 56 displays a notification screen 60 on a touch panel 32 of a terminal device 12 owned by the user who is the n-th paid member.

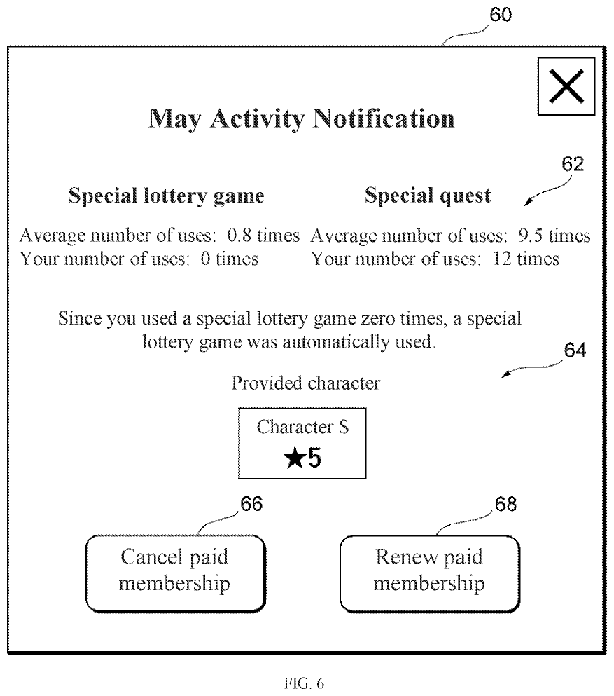

FIG. 6 is a diagram showing an example of the notification screen 60 according to one or more embodiments.

As shown in FIG. 6, the notification screen 60 is provided with a usage frequency information area 62, an automatic usage information area 64, a cancel button 66, and a renewal button 68. Information indicating the usage frequency of an advantage by the user for the fixed period and statistical information related to the usage frequency of that advantage are displayed in the usage frequency information area 62. This statistical information is information calculated in step SP10. Information indicating the result of automatically using an advantage whose usage frequency is less than a specific value is displayed in the automatic use information area 64. The cancel button 66 is used for giving an instruction to switch to a screen (cancellation screen) for canceling the paid membership after the next fixed period. The renewal button 68 is used to give an instruction to switch to a screen (renewal screen) for renewing the paid membership in the next fixed period and beyond.

Returning to FIG. 5, the processing moves to the processing of step SP26.

Step SP24

The update means 58 performs automatic updating in which the user who is the n-th paid member will be renewed as a paid member for the next fixed period. The processing then moves to the processing of step SP26.

Step SP26

The management means 54 determines whether or not the processing in step SP16, etc., has been performed for all users who are paid members for the fixed period. If this determination is positive, the series of processing shown in FIG. 5 is ended. On the other hand, if the determination is negative, the processing moves to the processing of step SP14.

Effect

In the above embodiments, a computer is made to function as the storage means 50 for storing whether or not a user is a paid member for a fixed period, the provision means 52 for providing an advantage in the game to a user who is a paid member for the fixed period, the management means 54 for managing the usage frequency of advantages by a user who is a paid member for the fixed period, and the notification means 56 for sending a user who is a paid member notification information including the usage frequency as the fixed period elapses.

With this configuration, since the usage frequency of advantages by a user who is a paid member is conveyed to the user, the user can check his frequency of usage of advantages, which is a basis for determining whether or not to renew as a paid member. This prevents users who are paid members from suffering a disadvantage.

Also, in one or more embodiments, the notification means 56 sends notification information to users whose usage frequency of advantages during a portion of or over the entire fixed period is less than a specific value.

According to this configuration, since a notification including the usage frequency is sent to a user who has not sufficiently used the advantages for the fixed period, the user can be prevented from suffering a disadvantage.

Also, in one or more embodiments, the notification information includes statistical information related to the usage frequency of advantages during a portion of or over the entire fixed period.

With this configuration, since statistical information related to the usage frequency of advantages is conveyed, users who do not sufficiently use advantages can compare their own usage frequency with the statistical information, and more easily decide whether or not to renew as paid members.

Also, in one or more embodiments, the notification information includes information to display a screen for instructing the cancellation of paid membership.

With this configuration, since the notification screen includes information with which the user can give an instruction to cancel the paid membership, the user can cancel his paid membership more conveniently.

Also, in one or more embodiments, the notification information includes information indicating that the advantage to be provided in the next fixed period will be automatically changed.

With this configuration, since the user is notified that the advantage to be provided in the next fixed period will be automatically changed, this motivates the user to renew his paid membership.

Also, in one or more embodiments, the notification information includes information to display a screen on which the user can arbitrarily change the advantage to be provided in the next fixed period.

With this configuration, since the notification screen includes information that allows the user to arbitrarily change the advantage to be provided in the next fixed period, this motivates the user to renew his paid membership.

Also, in one or more embodiments, the notification information includes information to display a screen for the user to use an advantage.

With this configuration, since the notification screen includes information that allows an advantage to be used, this encourages a user who is a paid member to use the advantage.

Also, in one or more embodiments, the notification information includes information indicating that the advantage has been automatically used.

With this configuration, since an advantage is used automatically, this ensures fairness with users who are sufficiently using the advantage.

Also, in one or more embodiments, a computer is made to function as the update means 58 for performing automatic updates that allow users whose usage frequency of an advantage during a portion of or over the entire fixed period is equal to or greater than a specific value to renew as paid members for the next fixed period as well.

With this configuration, a user who has sufficiently used an advantage can automatically renew as a paid member for the next fixed period, which means that the user can avoid the bother of having to manually renew his paid membership.

Modifications

The present invention is not limited to or by the specific examples given above. Specifically, even if a person skilled in the art were to make appropriate design changes to the above embodiments, these would also be included in the scope of the present invention so long as it had the features of the present invention. Also, the elements included in the above embodiments and in the modification examples given below could be combined whenever technically possible, and such combinations would also be encompassed by the scope of the present invention so long as the features of the present invention are included.

For example, in the above embodiments, the usage frequency was the number of times the user used an advantage during the fixed period, but a value obtained by dividing the number of uses by the number of available uses (remaining number) (such as a usage ratio or a usage rate) may be used instead.

Also, in the above embodiments, a case was described in which the management means 54 acquired the usage frequency associated with an advantage of the user in step SP16, but the number of available uses associated with the advantage may be acquired instead. In this case, the management means 54 determines whether or not the number of available uses of the advantage acquired in step SP18 is equal to or greater than a specific value. Examples of this specific value include a specific number of times (such as zero times), and a value based on statistical information (such as the mean value, median value, or mode value) of the number of available uses associated with an advantage of each user who is a paid member.

In the above embodiments, a case was described in which the advantage included the right to use an event, such as a special lottery game or a special quest, but the details of this event may be changed according to how long the user has been a paid member. For example, special lottery games and special quests may be changed to be more advantageous to users who have been paid members longer. More specifically, if the user has been a paid member for a short time, the provision means 52 provides a special lottery game in which characters of high rarity appear less frequently, and if the user has been a paid member for a long time, a special lottery game is provided in which characters with high rarity appear more frequently. Also, if the user has been a paid member for a short time, the provision means 52 provides a special quest that is set with a clearance reward of low value and quantity, and if the user has been a paid member for a long time, a special quest that is set with a clearance reward of high value and quantity is provided. Also, for example, the provision means 52 may provide a special lottery game, a special quest, or the like to a user on condition that the user continues to be a paid member for two or more fixed periods.

In the above embodiments, a case was described in which the notification means 56 sent notification information including a cancel button for instructing the cancellation of paid membership, but if a value indicating that paid membership will not be renewed is included in the renewal information of the qualification information in the user information 50A, a cancel button may not be included in the notification information. That is, the notification means 56 may not include a cancel button in the notification information if the user has already issued an instruction to cancel his paid membership for the fixed period.

Also, in the above embodiments, a case was described in which there were paid members and general members, as the membership types of users, but there may be a plurality of types of paid members. For example, for first paid members, the price and quantity of the advantages to be provided during the fixed period may be lower to correspond to a lower fee set for each fixed period. On the other hand, for second paid members, the price and quantity of the advantages to be provided during the fixed period may be higher to correspond to a higher fee set for each fixed period. In this case, the notification means 56 may send out notification information including information (type change button) for instructing to change the type of paid membership.

Also, in the above embodiments, a case was described in which the notification means 56 sent notification information to users whose usage frequency of an advantage was less than a specific value, but notification information may also be sent to users whose usage frequency is equal to or greater than a specific value. In this case, the notification means 56 sends users whose usage frequency is equal to or greater than a specific value notification information including automatic update information indicating that the paid membership will renew after the next fixed period, statistical information related to usage frequency of advantages, a cancel button for instructing to cancel the paid membership, a renewal button for instructing to renew the paid membership, and so forth.

Also, in the above embodiments, a case was described in which the notification means 56 sent notification information including the advantage change information for automatically changing the advantage to be provided in the next fixed period (such as the month of June), but this advantage change information may instead be information for automatically altering the advantage to be provided for a fixed period (such as the month of May). Similarly, a case was described in which the notification means 56 sent notification information including an advantage change button that allowed the user to arbitrarily change the advantage to be provided in the next fixed period, but this advantage change button may instead be a button (information) for arbitrarily changing the advantage to be provided for a fixed period. In these cases, the notification means 56 preferably sends the notification information within the fixed period.

Also, in the above embodiments, a case was mainly described in which the content was a character, but the content may instead be an item such as a weapon or armor, or a card, an avatar, coins, points, or the like.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

10 . . . server device (computer), 12 . . . terminal device, 50 . . . storage means, 52 . . . provision means, 54 . . . management means, 56 . . . notification means, 58 . . . update means

What is claimed is:

1. An information processing method comprising:
storing in a storage, information indicating that a user is a paid member for a fixed period;
providing an advantage in a game to the user for the fixed period;
managing usage frequency of the advantage by the user for the fixed period; and
sending the user notification information including the usage frequency as the fixed period elapses.

2. The information processing method according to claim 1 further comprising: sending the notification information to the user whose usage frequency during a portion of or over an entire period of the fixed period is less than a specific value.

3. The information processing method according to claim 2, wherein the notification information includes statistical information related to the usage frequency during a portion of or over an entire period of the fixed period.

4. The information processing method according to claim 2, wherein the notification information includes information to display a screen showing an instruction of cancellation of paid membership.

5. The information processing method according to claim 2, wherein the notification information includes information indicating that the advantage to be provided in a next fixed period will be automatically changed.

6. The information processing method according to claim 2, wherein the notification information includes information to display a screen on which the user arbitrarily changes the advantage to be provided in a next fixed period.

7. The information processing method according to claim 2, wherein the notification information includes information to display a screen on which the user uses the advantage.

8. The information processing method according to claim 2, wherein the notification information includes information indicating that the advantage has been automatically used.

9. The information processing method according to claim 1 further comprising: performing automatic updates that allow the user whose usage frequency of the advantage during a portion of or over an entire period of the fixed period is equal to or greater than a specific value to renew as the paid member for a next fixed period.

10. An information processing device comprising:
a storage that stores information indicating that a user is a paid member for a fixed period; and
a controller that:
provides an advantage in a game to the user for the fixed period;
manages usage frequency of the advantage by the user for the fixed period; and
sends the user notification information including the usage frequency as the fixed period elapses.

11. A non-transitory computer-readable medium storing instructions, wherein when the instructions are executed, the instructions cause a computer to execute operations comprising:
storing in a storage, information indicating that a user is a paid member for a fixed period;
providing an advantage in a game to the user for the fixed period;
managing usage frequency of the advantage by the user for the fixed period; and
sending the user notification information including the usage frequency as the fixed period elapses.
